(19) United States
(12) Patent Application Publication
(10) Pub. No.: US 2016/0096987 A1
(43) Pub. Date: Apr. 7, 2016

(54) Microscale Interface Materials for Enhancement of Electronics Performance

(71) Applicants: Jiali Wu, Yorktown Heights, NY (US); Kellsie Shan, Carmel, NY (US)

(72) Inventors: Jiali Wu, Yorktown Heights, NY (US); Kellsie Shan, Carmel, NY (US)

(73) Assignee: Qualsig Incorporation, Carmel, NY (US)

(21) Appl. No.: 14/508,107

(22) Filed: Oct. 7, 2014

(51) Int. Cl. C09K 5/14

(52) U.S. Cl. CPC C09K 5/14

(57) ABSTRACT

A thermally conductive interface material is in need to electronic packaging to meet escalated heat dissipation for performance demanding electronics. To survive thermal mismatch introduced stress at an interface of nominal thickness of 200 um and below between electronic component and heat spreader, a thermally conductive silicone gel comprises (A) a trimethyl-terminated organopolysiloxane containing a silicone-bonded alkenyl group or groups, (B) an alkeny-terminated organopolysiloxane, (C) thermally conductive filler with addition of nano particles, (D) an organohydrogen-polysiloxane, (E) an addition reaction catalyst, (F) a catalytic reaction inhibitor, and (G) an alkoxysilane bonding agent. The interface material provides thermal conductivity with low complex storage modulus.

### BACKGROUND

Electronic component such as multi-core processor generates heat during operation and the heat needs to be dissipated efficiently for the device to function properly. A common expedient for this purpose is to transfer heat from electronic component (FIG. 1-5, FIG. 2-5) to a heat spreader (FIG. 1-2, FIG. 2-2), and then to heat sink (FIG. 1-1, FIG. 2-1) through an integrated thermal path, which was established by attaching a heat spreader directly on the silicon electronic component, and then a heat sink on the heat spreader using thermally conductive interface materials (FIG. 1-3, 4; FIG. 2-3,4). Effectiveness of heat dissipation is dominated by thermal conductivity and mechanical integrity of the interface materials.

Due to the relentless pursuit of computing performance and functionality, improving heat dissipation becomes one of the central challenge issues. The recent trend in microprocessor architecture has been to increase the number of transistors, shrink processor size, and increase clock speeds in order to meet the market demand. As a result, the high-end microelectronic components are experiencing ever growing total power dissipation and heat fluxes, which increase the demand for effective means of heat dissipation.

Thermally conductive interface material plays a key role in terms of thermal dissipation efficacy of the integrated single chip module (SCM) and multi chip module (MCM) electronic packages as shown in FIG. 1 and FIG. 2. Processor chips are bonded to chip carriers (FIG. 1-8, FIG. 2-8) via flip chip interconnect (FIG. 1-6, FIG. 2-6) to reduce package size and increase module electrical and thermal performance. The nominal thickness of bonding interfaces (also called bond line thickness—BLT, FIG. 1-3, 4 and FIG. 2-3, 4) filled with thermal interface material is typically about 200 um and below. High end SCMs or MCMs are commonly assembled onto functional substrates via ball grid array (BGA, FIG. 1-7, FIG. 2-7) and other interconnection means to form system package. The integrated SCM or MCM see multiple thermal excursions at a peak temperature as high as 265 C during module assembly. For organic packages, thermal interface material experiences tremendous mechanical stress during module assembly processes. To retain an intimate interface adhesion as well as to absorb mechanical stress, a thermally conductive interface material has to be gel like with low modulus but high thermal conductivity. The present invention provides a capable thermally conductive gel which satisfies the aforementioned stringent characteristics.

There have been known a variety of addition curable polysiloxane composition, including those which comprising an organopolysiloxane containing a silicon bonded vinyl group, organopolysiloxane containing a bonded hydrogen, and non-functional polysilicone oil. However, due to the further increase in power assumption, which results in high heat density on electronic component, a sufficient heat dissipation effect cannot be obtained using traditional thermally conductive material. Furthermore, oil bleeding from gel-like cured material could cause contamination and short circuit. (Patent: JP-A 2003-301189, JP-A 2002-294269).

### BRIEF DESCRIPTION OF DRAWINGS

FIG. 1 is an integrated Single Chip Module (SCM) with a heat spreader and a sink.

FIG. 2 is an integrated Multi Chip Module (MCM) with a heat spreader and a sink.

### SUMMARY OF INVENTION

It is accordingly an object of this present invention to provide a gel-forming silicone composition excelling thermal conductivity with low viscosity, low modulus, flexibility, and not prone to oil bleeding. To achieve this goal, the present invention comprises a curable silicone gel with thermally conductive filler loading. Before cure, the materials have properties similar to grease, they have high thermal conductivity, low surface energies, and conform well to surface irregularities upon dispense and assembly, which contributes to thermal contact resistance minimization. After cure, the crosslink reaction provides cohesive strength to circumvent the pump-out issues exhibited by grease during temperature cycling. Their modulus is low that the material can dissipate thermal stress and prevent interfacial delamination.

The formulation of present invention comprising:

(A) A linear alkenyl organopolysiloxane containing a silicon-bonded alkenyl-terminated group or groups in an average amount of about 1 to 5 mol %, preferred from 2-3 mol % based on the amount of all silicon-bonded organic groups contained per molecule. The alkenyl group containing organopolysiloxane having the following composition (1):

R¹(R²)ₐ(R³)_{b}SiO_{(4-a-b)/2}ₙSiR²R³R¹ (1)

wherein R¹ is an alkenyl group, R² and R³ are substituted or unsubstituted monovalent hydrogencarbon groups, and a and b are integers having values such that a 0≦a<3, b=2-a. n is a integer from 5-100.

In the above formula (1), R¹ is preferably an akenyl group of from 2 to 8 carbons. Specific examples include vinyl, allyl, 1-butenyl and 1-hexenyl groups and the like.

In the above formula (1), R² and R³ are preferably substituted or unsubstituted monovalent hydrogencarbon groups. Examples of R² and R³ include alkyl groups such as methyl, ethyl, propyl, isopropyl, butyl, octyl, and the likes; cycloalkyl groups such as cyclopentyl, cyclohexyl, cyclobutyl and the like; aryl groups such as phenyl, xylyl, naphthyl, and the likes. Aralkyl groups such as benzyl, phenylethyl, phenlpropyl, and the likes; and groups derived from these hydrogen groups by substitution of part or all of the carbon-bonded hydrogen atoms in these hydrogen groups with a halogen atom, cyano group or the likes, such as chloromethyl, trifluoropropyl, cholophenyl, diflorophenyl, and the likes. Alkylene groups may be formed from R² and R³, for example, ethylene, trimethylene, methylmethylene, tetramethylene, and hexamethylene groups and the likes.

The component (A) preferably has a viscosity at 25 C of the order of 200-1500 cP to ensure that the composition mixture obtained will have a suitable fluidity before cure and exhibit suitable physical properties after cure where it is used as thermally conductive interface materials in the applications of SCM, MCM, LED, solar cell, MEMS, biomedical appliances.

(B) A branched alkenyl organopolysiloxane containing silicon-bonded alkenyl groups in an average amount of about 0.1 to 0.5 mol %, preferably from 0.15-0.2 mol % based on the amount of all silicon-bonded organic groups contained per molecule. Each organopolysiloxane molecular has more than 2 alkenyl groups. Each alkenyl groups is bonded to a silicon atom located at an intermediate position and terminal position of the molecular chain. The alkenyl group containing organopolysiloxane having the following average composition formula (2):

(R⁴)_{c}(R⁵)_{d}SiO_{(4-c-d)/2} (2)

wherein R⁴ is an alkenyl group, R⁵ is a substituted or unsubstituted monovalent hydrogencarbon groups, and c and d have values such that 0<d<3, and 0.001≦c/(c+d)≦0.003.

In the above formula (2), R⁴ is preferably an akenyl group of from 2 to 8 carbons. Specific examples include vinyl, allyl, 1-butenyl and 1-hexenyl groups and the like.

In the above formula (2), R⁵ is preferably substituted or unsubstituted monovalent hydrogencarbon groups. Examples of R⁵ include alkyl groups such as methyl, ethyl, propyl, isopropyl, butyl, octyl, and the likes; cycloalkyl groups such as cyclopentyl, cyclohexyl, cyclobutyl and the likes; aryl groups such as phenyl, xylyl, naphthyl, and the likes. Aralkyl groups such as benzyl, phenylethyl, phenlpropyl, and the likes; and groups derived from these hydrogen groups by substitution of part or all of the carbon-bonded hydrogen atoms in these hydrogen groups with a halogen atom, cyano group or the likes, such as chloromethyl, trifluoropropyl, cholophenyl, diflorophenyl, and the likes. Alkylene groups may be formed from two R⁵'s includes, for example, ethylene, trimethylene, methylmethylene, tetramethylene, and hexamethylene groups and the likes.

The component (B) preferably has a viscosity at 25 C of the order of 200-3000 cP to ensure the composition obtained will have a suitable fluidity before cure and exhibit suitable elasticity after cure.

Weight or volume ratio of compound (A) to (B) is from 20:1 to 1:10, preferably from 10:1 to 1:5.

(C) Thermally Conductive Filler

There is a wide range of thermal fillers can be used in the practice of the invention. Examples of these fillers include metals, such as aluminum, copper, gold, silver and the like, ceramics, such as aluminum oxide, aluminum nitride, silicon carbide, diamond, zinc oxide, boron nitride, and the like, silver coated aluminum, carbon fibers, alloys and any combinations thereof. Aluminum and copper are preferred because of their demonstrated thermal conductivity, availability and cost effectiveness. Surface of the thermally conductive fillers are rendered hydrophobic by treatment with organopolysiloxane, organopolysilane, hydroxyl stearic acid ester, or other type of dispersant.

In present invention, a mixture of thermally conductive particle composition is mixed with organic vehicle to enhance the thermal conductivity. To lower the relative viscosity of the mixture at the same filler loading percent, particles in spherical or cubic octahedral shape are preferred. The average size of large particle must be selected in a range that balances bonding interface thickness and thermal conductivity effectiveness for an interface material. Addition of small particles is to increase the particle packing density, so as to the thermal conductivity. The effect of adding nano particle is to disentangle polymeric chain and reduce contact interface between micro size particles and polymer liquid matrix, which leads to further increasing of filler loading in thermally conductive mixtures with marginal viscosity budget.

(D) Organohydrogenpolysiloxane

An organohydrogenpolysiloxane containing at least two Si—H terminated groups per molecule. It acts as cross-linker agent to react with alkenyl group in component (A) and (B) to form gel-like polymer with low cross-link density. The SiH may present at terminal or intermediate position of the molecule. The average composition formula contained in orgaohydrogenpolysiloxane is (3):

(R⁶)ₑH_{f}SiO_{(4-e-f)/2} (3)

Wherein R⁶ is a substituted or unsubstituted monovalent hydrocarbon group, and e and f have values such that 0<e<3, 0<f≦2, and 1≦e+f≦3. The compounds may have one or combined liner, branched and cyclic structures.

In the above formula (3), R⁶ is substituted or unsubstituted monovalent hydrocarbon group, and two R⁶'s may connected to form a lower alkylene group. R⁶ groups include, for example, the groups mentioned above as component R². Linear organohydrogenpolysiloxane with SiH terminated group or groups in a viscosity no greater than 800 cP at 25 C is preferable for composition with low fluidity consideration.

For ensuring the gel-like composition post cure without oil bleeding, the amount of component (D) is preferable as such to provide from 0.5-0.8 moles of SiH groups per mole of alkenyl groups in component (A) and (B).

(E) Addition Reaction Catalyst

The addition reaction catalyst for the present invention can be any catalyst promotes the hydrosilylation reaction between component (A) (B) and (D). Examples include platinum chloride, chloroplatinic acid, a complex of chloroplatinic acid and an olefin or vinylsiloxane, platinum bisacetoacetate and th

e like. The blending amount of component (E) cab be adjusted according to desired curing rate. The preferable amount of platinum in platinum compound (E) for present invention falls in a range of 1-100 ppm to the total amount of the curable silicone composition of (A), (B) and (D).

(F) Reaction Inhibitor

A reaction inhibitor may be added as an optional component in order to maintain appropriate curing reactivity and storage stability. Example of reaction inhibitor are acetylenic alcohols such as 3,5-dimethyl-1-hexyn-3-ol, 2-methyl-3-hexyn-2-ol, 3-methyl-3-penetene-1-yne, 1-ethynylcyclohexanol, or methylvinylsiloxane cyclic compounds, or an organic nitrogen compounds, and the like.

(G) Alkoxysilane

An alkoxysilane serves as a bonding agent to promote the bonding strength between thermally conductive filler (C) and silicone resin of component (A), (B) and (D). The alkoxysilanes are presented by formula (4). R⁷ in the formulae may be the same or different. Each R⁷ group represents a 6-30 unsubstituted or substituted monovalent hydrocarbon group including, for examples, the groups mentioned above as component R². Among these groups, 10-18 C alkyl groups are preferred over the others.

R⁷_{g}Si(OR⁸)_{(4-g)} (4)

R⁸ groups in the above formula may be the same or different, and each R⁸ groups represent as a 1-6 C alkyl groups. Examples of an alkoxy group as OR⁸ include methoxyl, ethoxyl, propoxyl, butoxyl, isopropoxyl, and the likes. g in the above formula is an integer of 1, 2 or 3, and the case of g=1 is particular desirable for the alkoxysilane.

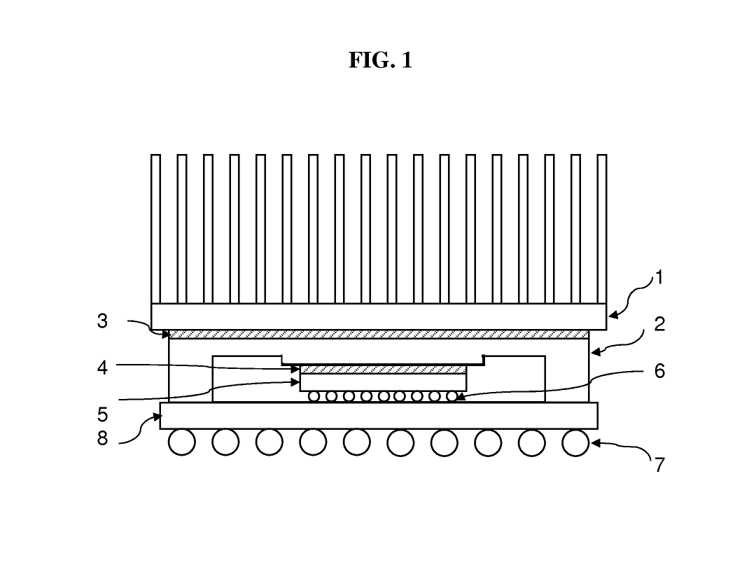

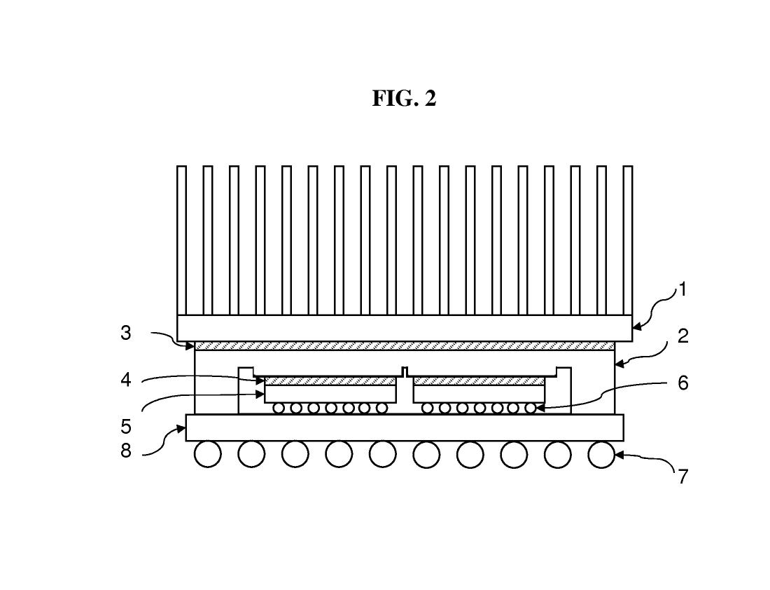

A thermally conductive interface material of silicone gel based comprises 60-90 vol % heat conductive particles, preferred 75-85 vol %. A single particle size, or a binary or ternary particle size combination are loaded into an aforementioned silicone matrix based on a balance of interface thickness, viscosity, modulus and thermal conductivity. The thermally conductive interface gel of present invention can be cured at 100 C to 150 C with varied time period. The complex storage modulus of thermal gel cured at 125 C for 30 min is less than 100 kPa measured at a 10% strain displacement shear condition at 125 C. In a semiconductor packaging and integration application, the thermally conductive interface material is applied between a silicon chip or chips and a heat spreader (shown in FIG. 1-4, FIG. 2-4) or heat spreader and heatsink (shown in FIG. 1-3, FIG. 2-3). In the application field, the thermal interface gel serves as a heat transfer media to dissipate heat from chip to the heat spreader (FIG. 1-2, FIG. 2-2), and then to the heatsink (FIG. 1-1, FIG. 2-1). A typical thickness of thermal interface material is 200 um and below.

### Mixing, Curing and Thermal Conductivity Measurement

In preparing a thermally conductive interface silicone gel of the present invention, the components (A) to (F) as mentioned above are mixed with a planetary mixer, three-roll mill, or three-rod kneader, etc. at 25 C or a raised temperature up to 80 C. The thoroughly mixed composition can be cured at a temperature from 100 C to 150 C. The cured thermally conductive gel has a complex storage modulus less 100 kPa under a 10% strain displacement shear condition at 125 C.

Thermal conductivity of interface silicone gel with different organic components was measured using NanoFlash thermal conductivity analyzer. A layer of the thermal interface material with a thickness of 75 um was sandwiched between two circular aluminum plates of diameter 12.6 mm and thickness of 2 mm. the sample was applied by a pressure of 20 psi at 25 C for 15 min and then subjected to 125 C for 30 min.

### Examples

The raw materials for examples 1-8 were uniformly mixed according to the amounts as given in table I.

The compounds used as component (A) are A-1 and A-2. They are linear alkenyl-terminated organopolysiloxane represented on the average by the formula;

(ViMe₂SiO_{0.5})_{1.2}(Me₂SiO)_{138.2} A-1

(ViMe₂SiO_{0.5})_{1.3}(Me₂SiO)_{187.3}(Me₃SiO_{0.5})_{1.5}(MeSiO_{1.5})_{2.0}. A-2

wherein Me stands for the methyl group and Vi stands for the vinyl group. A-1 has vinyl group 0.43 mol %, viscosity 280 cP. A-2 has vinyl group mole 0.45% and viscosity 310 cP.

The compounds used as component (B) are B-1 to B-2. They are branched alkenyl-group containing organopolysiloxane represented on the average by formula:

(Me₃SiO_{0.5})_{0.75}(MeViSiO)_{1.5}(Me₂SiO)₅₅ B-1

(Me₃SiO_{0.5})_{1.0}(MeViSiO)_{1.7}(Me₂SiO)₅₉(MeSiO_{1.5})_{1.5} B-2

wherein B-1 having vinyl group 0.30 mol %, viscosity 450 cP. B-2 having vinyl group 0.35 mole % and viscosity 500 cP.

The thermally conductive filler used as component C is aluminum. C-1 is aluminum with particle size from 5-10 um. C-2 is alumina with particle size from 100-1000 nm.

The compounds used as component (D) are D-1 and D-2. They are organohydropolysiloxane represented on the average by formula:

(HMe₂SiO_{0.5})_{2.0}(Me₂SiO)₁₆ D-1

(HMe₂SiO_{0.5})_{2.0}(Me₂SiO)₃₂(Me₃SiO_{0.5})_{1.0} D-2

wherein D-1 has a viscosity of 18 cP, and D-2 has viscosity of 20 cP.

The compound used as component (E) is a catalyst of chloroplatinic acid-vinylsiloxane complex.

The compounds used as component (G) are G-1 and G-2. They are alkylsilane represented on the average by formula:

(MeO)₃SiO(Me₂SiO)₁₅(OSiMe₃) G-1

(MeO)₂Me₃SiO(Me₂SiO)₂₀(OSiMe₃) G-2

wherein G-1 has a viscosity of 12 cP, and G-2 has viscosity of 16 cP.

Examples 1-8 comprise 75-85 volume % of thermally conductive particles in silicone liquid matrix.

The composition of examples 1-8 are listed in table I. 0.5 g of the thermal interface material with a thickness of 75 um was sandwiched between two circular aluminum plates of diameter 12.6 mm with a thickness of 2 mm. The sample was applied by a pressure of 20 psi at 25 C for 15 min and then subjected to 125 C for 30 min for storage modulus measurement.

TABLE I

| | Examples | | | | | | | |
|---|---|---|---|---|---|---|---|---|
| | Amount in Volume Part | | | | | | | |
| Compound ID | 1 | 2 | 3 | 4 | 5 | 6 | 7 | 8 |
| Compound A | | | | | | | | |
| A-1 | 100 | 100 | | | 150 | 180 | 200 | 250 |
| A-2 | | | 100 | 100 | | | | |
| Compound B | | | | | | | | |
| B-1 | 200 | | 220 | | | 120 | | 50 |
| B-2 | | 200 | | 215 | 150 | | 100 | |
| Compound C | | | | | | | | |
| C-1 | 1200 | 1000 | 1300 | 900 | 1350 | 900 | 700 | 800 |
| C-2 | | 350 | | 450 | | 500 | 700 | 600 |
| Compound D | | | | | | | | |
| D-1 | 4.46 | 4.21 | 5.01 | 5.13 | | 5.52 | 5.01 | |
| D-2 | | | | | 4.51 | | | 5.03 |
| Compound E | 0.05 | 0.055 | 0.05 | 0.055 | 0.045 | 0.05 | 0.045 | 0.045 |
| Compound G | | | | | | | | |
| G-1 | 10 | | 8 | | 15 | 15 | | 8 |
| G-2 | | 10 | | 10 | | | 10 | |
| G′ Modulus (kPa) | 53 | 54 | 54 | 54 | 58 | 54 | 54 | 53 |
| Thermal | 6.5 | 7.0 | 6.5 | 7.1 | 6.6 | 7.2 | 7.4 | 7.3 |
| Conductivity | | | | | | | | |
| (W/k · m) | | | | | | | | |

What we claims:

4. A thermally conductive interface material formulation comprises
(A) A linear alkenyl organopolysiloxane containing a silicon-bonded alkenyl-terminated group or groups of the general molecular composition (1):
R¹(R²)ₐ(R³)_{b}SiO_{(4-a-b)/2}ₙSiR²R³R¹ (1)
wherein R¹ is an alkenyl group of 2 to 8 carbons, R² and R³ are substituted or unsubstituted monovalent hydrogencarbon groups, a and b are integers satisfying 0≦a<3, b=2-a, n is a integer of 5-200.
(B) A branched alkenyl organopolysiloxane containing silicon-bonded alkenyl groups with the average composition formula (2):
(R⁴)_{c}(R⁵)_{d}SiO_{(4-c-d)/2} (2)
wherein R⁴ is an alkenyl group, R⁵ is an substituted or unsubstituted monovalent hydrogencarbon groups, c and d are integers satisfying 0<d<3, 0.001≦c/(c+d)≦0.003.
Weight or volume ratio of compound (A) to (B) is 20:1 to 1:10.
(C) A thermally conductive filler consisting alumina of a mean particle size of 100-5000 nm and aluminum of a mean particle size 5-100 um with a ratio of 0 to 1.
(D) An organohydrogenpolysiloxane containing at least two Si—H terminated groups with a viscosity no greater than 800 cP at 25 C.
Mole ratio of Si—H groups in component (D) to alkenyl groups in component (A) and (B) combined is 0.5 to 0.8.
(E) A catalyst selected from a group of platinum compounds with an amount of platinum in a range of 1-100 ppm to the total amount of the curable silicone composition of (A), (B) and (D).
(F) A optional inhibitor to maintain appropriate storage stability.
(G) A alkoxysilane for enhancement of bonding strength between thermal filler component (C) and silicone resin (A), (B) and (D).

5. The thermally conductive interface material said in claim 1 possessing a complex storage modulus less than 100 kPa at 125 C after cure at 125 C for 30 min.

6. The thermally conductive interface material said in claim 1 to be applied between semiconductor chip and heat spreader (or heat sink) in a sandwich formation with a thickness of 200 um and below, wherein transporting heat generated from chip to heat spreader (or heatsink).
